(19) United States
(12) Patent Application Publication
(10) Pub. No.: US 2013/0240355 A1
(43) Pub. Date: Sep. 19, 2013

(54) FUNCTIONALIZATION OF GRAPHENE HOLES FOR DEIONIZATION

(71) Applicants: Gregory S. Ho, Cherry Hill, NJ (US); Rex G. Bennett, Haddon Township, NJ (US); Peter V. Bedworth, Los Gatos, CA (US); John B. Stetson, JR., New Hope, PA (US)

(72) Inventors: Gregory S. Ho, Cherry Hill, NJ (US); Rex G. Bennett, Haddon Township, NJ (US); Peter V. Bedworth, Los Gatos, CA (US); John B. Stetson, JR., New Hope, PA (US)

(73) Assignee: LOCKHEED MARTIN CORPORATION, Bethesda, MD (US)

(21) Appl. No.: 13/422,753

(22) Filed: Mar. 16, 2012

(51) Int. Cl. B01D 61/42; B01D 61/00; B82Y 30/00; B82Y 40/00

(52) U.S. Cl. 204/451; 210/653; 210/641; 210/500.21; 204/601; 977/902; 977/847

(57) ABSTRACT

A method for deionization of a solution, the method comprising functionalizing plural apertures of a graphene sheet to repel first ions in the solution from transiting through the functionalized plural apertures. The non-transiting first ions influence second ions in the solution to not transit through the functionalized plural apertures. The graphene sheet is positioned between a solution flow path input and a solution flow path output. Solution enters the solution flow path input and through the functionalized plural apertures of the graphene sheet, resulting in a deionized solution on the solution flow path output side of the graphene sheet and a second solution containing the first ions and second ions on the solution flow path input side of the graphene sheet.

### FIELD OF THE INVENTION

The present invention relates to ion filtration, and more particularly to a method and system for deionization using functionalization of graphene holes.

### BACKGROUND OF THE INVENTION

As fresh water resources are becoming increasingly scarce, many nations are seeking solutions that can convert water that is contaminated with salt, most notably seawater, into clean drinking water.

Existing techniques for water desalination fall into four broad categories, namely distillation, ionic processes, membrane processes, and crystallization. The most efficient and most utilized of these techniques are multistage flash distillation (MSF), multiple effect evaporation (MEE) and reverse osmosis (RO). Cost is a driving factor for all of these processes, where energy and capital costs are both significant. Both RO and MSF/MEE technologies are thoroughly developed. Currently, the best desalination solutions require between two and four times the theoretical minimum energy limit established by simple evaporation of water, which is in the range of 3 to 7 kjoules/kg. Distillation desalination methods include multistage flash evaporation, multiple effect distillation, vapor compression, solar humidification, and geothermal desalination. These methods share a common approach, which is the changing of the state of water to perform desalination. These approaches use heat-transfer and/or vacuum pressure to vaporize saline water solutions. The water vapor is then condensed and collected as fresh water.

Ionic process desalination methods focus on chemical and electrical interactions with the ions within the solution. Examples of ionic process desalination methods include ion exchange, electro-dialysis, and capacitive deionization. Ion exchange introduces solid polymeric or mineral ion exchangers into the saline solution. The ion exchangers bind to the desired ions in solution so that they can be easily filtered out. Electro-dialysis is the process of using cation and anion selective membranes and voltage potential to create alternating channels of fresh water and brine solution. Capacitive deionization is the use of voltage potential to pull charged ions from solution, trapping the ions while allowing water molecules to pass.

Membrane desalination processes remove ions from solution using filtration and pressure. Reverse osmosis (RO) is a widely used desalination technology that applies pressure to a saline solution to overcome the osmotic pressure of the ion solution. The pressure pushes water molecules through a porous membrane into a fresh water compartment while ions are trapped, creating high concentration brine solution. Pressure is the driving cost factor for these approaches, as it is needed to overcome osmotic pressure to capture the fresh water. Crystallization desalination is based on the phenomenon that crystals form preferentially without included ions. By creating crystallized water, either as ice or as a methyl hydrate, pure water can be isolated from dissolved ions. In the case of simple freezing, water is cooled below its freezing point, thereby creating ice. The ice is then melted to form pure water. The methyl hydrate crystallization process uses methane gas percolated though a saltwater solution to form methane hydrate, which occurs at a lower temperature than at which water freezes. The methyl hydrate rises, facilitating separation, and is then warmed for decomposition into methane and desalinated water. The desalinated water is collected, and methane is recycled.

Evaporation and condensation for desalination is generally considered to be energy efficient, but requires a source of concentrated heat. When performed in large scale, evaporation and condensation for desalination are generally co-located with power plants, and tend to be restricted in geographic distribution and size.

Capacitive deionization is not widely used, possibly because the capacitive electrodes tend to foul with removed salts and to require frequent service. The requisite voltage tends to depend upon the spacing of the plates and the rate of flow, and the voltage can be a hazard.

Reverse osmosis (RO) filters are widely used for water purification. The RO filter uses a porous or semipermeable membrane typically made from cellulose acetate or polyimide thin-film composite, typically with a thickness of 1 millimeter (mm). These material are hydrophilic. The membrane is often spiral-wound into a tube-like form for convenient handling and membrane support. The membrane exhibits a random-size aperture distribution, in which the maximum-size aperture is small enough to allow passage of water molecules and to disallow or block the passage of ions such as salts dissolved in the water. Notwithstanding the one-millimeter thickness of a typical RO membrane, the inherent random structure of the RO membrane defines long and circuitous or tortuous paths for the water that flows through the membrane, and these paths may be much more than one millimeter in length. The length and random configuration of the paths require substantial pressure to strip the water molecules at the surface from the ions and then to move the water molecules through the membrane against the osmotic pressure. Thus, the RO filter tends to be energy inefficient.

FIG. 1 is a notional illustration of a cross-section of an RO membrane 10. In FIG. 1, membrane 10 defines an upstream surface 12 facing an upstream ionic aqueous solution 16 and a downstream surface 14. The ions that are illustrated on the upstream side are selected as being sodium (Na) with a + charge and chlorine (CI) with a − charge. The sodium is illustrated as being associated with four solvating water molecules (H₂O). Each water molecule includes an oxygen atom and two hydrogen (H) atoms. One of the pathways 20 for the flow of water in RO membrane 10 of FIG. 1 is illustrated as extending from an aperture 20u on the upstream surface 12 to an aperture 20d on the downstream surface 14. Path 20 is illustrated as being convoluted, but it is not possible to show the actual tortuous nature of the typical path. Also, the path illustrated as 20 can be expected to be interconnected with multiple upstream apertures and multiple downstream apertures. The path(s) 20 through the RO membrane 10 are not only convoluted, but they may change with time as some of the apertures are blocked by unavoidable debris.

Alternative water desalination methods and apparatus are desired.

### SUMMARY OF THE INVENTION

A method for deionization of a solution is disclosed, the method comprising the steps of: functionalizing plural apertures of a graphene sheet to repel first ions in the solution from transit through the functionalized plural apertures, the non-transiting first ions influencing second ions in the solution to not transit through the functionalized plural apertures; positioning the graphene sheet in between a solution flow path input and a solution flow path output; and causing a solution to enter the solution flow path input and through the functionalized plural apertures of the graphene sheet, thereby resulting in a deionized solution on the solution flow path output side of the graphene sheet and a second solution containing the first ions and second ions on the solution flow path input side of the graphene sheet.

In an embodiment, the first ions may be negatively charged ions, the second ions may be positively charged ions, and functionalizing the plural apertures may comprise functionalizing perimeters of the plural apertures to have a negative charge to repel the negatively charged ions in the solution. Functionalizing the perimeters of the plural apertures to have a negative charge may comprise functionalizing the perimeters using oxygen, nitrogen, phosphorous, sulfur, fluorine, chlorine, bromine, or iodine. Alternatively, functionalizing the perimeters of the plural apertures to have a negative charge may comprise functionalizing the perimeters using polymer chains or amino acid chains having an overall negative charge. In another embodiment, the first ions may be positively charged ions, the second ions may be negatively charged ions, and functionalizing the plural apertures may comprise functionalizing perimeters of the plural apertures to have a positive charge to repel positively charged ions in the solution. Functionalizing perimeters of the plural apertures to have a positive charge may comprise functionalizing the perimeters using boron, hydrogen, lithium, magnesium, or aluminum. Alternatively, functionalizing the perimeters of the plural apertures to have a positive charge may comprise functionalizing the perimeters using polymer chains or amino acid chains having an overall positive charge.

The method for deionization may further comprise dimensioning the plural apertures of the graphene sheet to repel the transit of the first ions. The method may also further comprise applying an electrical charge to the graphene sheet, wherein the electrical charge repels the first ions.

A method for deionization of a solution is disclosed, the method comprising the steps of: functionalizing first plural apertures of a first graphene sheet to repel first ions in the solution from transit through the functionalized first plural apertures, the non-transiting first ions also influencing second ions in the solution to not transit through the functionalized first plural apertures; functionalizing second plural apertures of a second graphene sheet to repel second ions in the solution from transit through the functionalized second plural apertures, the non-transiting second ions also influencing first ions in the solution to not transit through the functionalized second plural apertures; positioning the first graphene sheet downstream of a solution flow path input and positioning the second graphene sheet between the first graphene sheet and a solution flow path output; and causing solution to enter the solution flow path input, through said first graphene sheet, then through said second graphene sheet, thereby resulting in a deionized solution at the solution flow path output.

In an embodiment, the first ions are negatively charged ions, the second ions are positively charged ions, functionalizing the first plural apertures comprises functionalizing first perimeters of the first plural apertures to have a negative charge to repel the negatively charged ions in the solution, and functionalizing the second plural apertures comprises functionalizing second perimeters of the second plural apertures to have a positive charge to repel the positively charged ions in the solution. Functionalizing the first perimeters of the first plural apertures to have a negative charge may comprise functionalizing the first perimeters of the first plural apertures using oxygen, nitrogen, phosphorous, sulfur, fluorine, chlorine, bromine, or iodine. Alternatively, functionalizing the first perimeters of the first plural apertures to have a negative charge may comprise functionalizing the first perimeters using polymer chains or amino acid chains having an overall negative charge. Functionalizing second perimeters of the second plural apertures to have a positive charge may comprise functionalizing the second perimeters using boron, hydrogen, lithium, magnesium, or aluminum. Alternatively, functionalizing second perimeters of the second plural apertures to have a positive charge may comprise functionalizing the second perimeters using polymer chains or amino acid chains having an overall positive charge.

In another embodiment, the first ions are positively charged ions, the second ions are negatively charged ions, functionalizing the first plural apertures comprises functionalizing first perimeters of the first plural apertures to have a positive charge to repel the positively charged ions in the solution, and functionalizing the second apertures comprises functionalizing second perimeters of the second plural apertures to have a negative charge to repel the negatively charged ions in the solution. Functionalizing second perimeters of the second plural apertures to have a negative charge may comprise functionalizing the second perimeters using oxygen, nitrogen, phosphorous, sulfur, fluorine, chlorine, bromine, or iodine. Alternatively, functionalizing the second perimeters of the second plural apertures to have a negative charge may comprise functionalizing the second perimeters using polymer chains or amino acid chains having an overall negative charge. Functionalizing first perimeters of the first plural apertures to have a positive charge may comprise functionalizing the first perimeters using boron, hydrogen, lithium, magnesium, or aluminum. Alternatively, functionalizing first perimeters of the first plural apertures to have a positive charge comprises functionalizing the first perimeters using polymer chains or amino acid chains having an overall positive charge.

The method may further comprise dimensioning the first plural apertures of the first graphene sheet to repel the transit of the first ions and dimensioning the second plural apertures of the second graphene sheet to repel the transit of the second ions. The method may also further comprise applying a first electrical charge to the first graphene sheet and a second electrical charge to the second graphene sheet, wherein said first electrical charge repels the first ions and said second electrical charge repels the second ions.

A deionizer is disclosed, comprising: a graphene sheet with plural apertures functionalized to repel first ions in a solution from transit through the plural apertures, the non-transiting first ions influencing second ions in the solution to not transit through the functionalized plural apertures; a solution flow path with an input and an output, wherein the graphene sheet is positioned between the solution flow path input and the solution flow path output; and a source of solution laden with ions. The solution laden with ions is introduced into the solution flow path input, passes through the graphene sheet, thereby resulting in a first ion solution containing the first ions and the second ions on a solution flow path input side of the graphene sheet and a deionized solution on a solution flow path output side of the graphene sheet.

In an embodiment, the first ions are negatively charged ions, the second ions are positively charged ions, and the functionalized plural apertures comprise plural apertures with negatively charged perimeters to repel the negatively charged ions in the solution. In another embodiment, the first ions are positively charged ions, the second ions are negatively charged ions, and the functionalized plural apertures comprise plural apertures with a positively charged perimeters to repel the positively charged ions in the solution.

The deionizer may further comprise plural apertures of the graphene sheet dimensioned to repel the transit of the first ions. The deionizer may also further comprise charging the graphene sheet with an electrical charge, the electrical charge repelling the first ions.

A solution deionizer is disclosed, comprising: a first graphene sheet with first plural apertures functionalized to repel first ions from transiting through the functionalized first plural apertures, the non-transiting first ions influencing second ions in the solution to not transit through the functionalized first plural apertures; a second graphene sheet with second plural apertures functionalized to repel the second ions in the solution from transiting through the functionalized second plural apertures, the non-transiting second ions influencing the first ions in the solution to not transit through the functionalized second plural apertures; a solution flow path with an input and an output, wherein the first graphene sheet is downstream from the solution flow path input and the second graphene sheet is between the first graphene sheet and the solution flow path output; and a source of solution laden with ions. The solution laden with ions is introduced into the solution flow path input, passes through the first graphene sheet, then passes through the second graphene sheet, thereby resulting in deionized solution at the solution flow path output.

In an embodiment, the first ions are negatively charged ions, the second ions are positively charged ions, the functionalized first plural apertures comprises first plural apertures with negatively charged perimeters that repel the negatively charged ions in the solution, and the functionalized second plural apertures comprises second plural apertures with positively charged perimeters that repel the positively charged ions in the solution. In another embodiment, the first ions are positively charged ions, and the second ions are negatively charged ions, the functionalized first plural apertures comprise first plural apertures with positively charged perimeters that repel the positively charged ions in the solution, and the functionalized second plural apertures comprise second plural apertures with negatively charged perimeters that repel the negatively charged ions in the solution.

The solution deionizer may further comprise the first plural apertures of the first graphene sheet being dimensioned to repel the transit of the first ions and the second plural apertures of the second graphene sheet being dimensioned to repel the transit of the second ions. The solution deionizer may also further comprise the first graphene sheet being charged with a first electrical charge and the second graphene sheet being charged with a second electrical charge, said first electrical charge repelling the first ions and said second electrical charge repelling the second ions.

### BRIEF DESCRIPTION OF THE DRAWINGS

FIG. 1 is a notional cross-sectional representation of a prior-art reverse osmosis (RO) filter membrane;

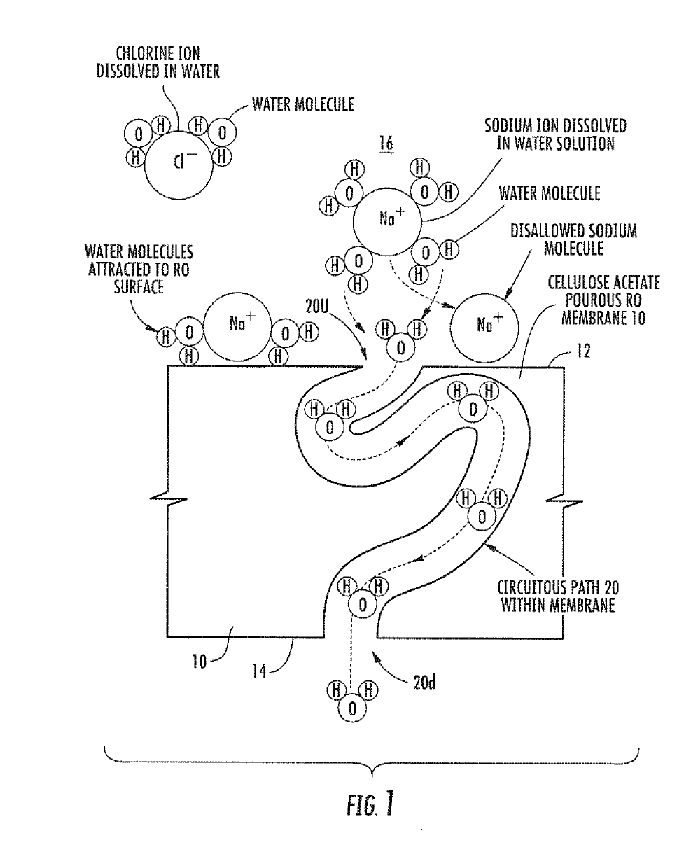

FIG. 2 is a notional representation of a water filter according to an aspect of the disclosure, using a perforated graphene sheet;

FIG. 3 is a plan representation of a perforated graphene sheet which may be used in the arrangement of FIG. 2, showing the shape of one of the plural apertures;

FIG. 4 is a plan view of a perforated graphene sheet, showing functionalized perforations or apertures and dimensions;

FIG. 5 is a plan representation of a backing sheet that may be used in conjunction with the perforated graphene sheet of FIG. 2;

FIG. 6 is a notional representation of a water deionization filter according to aspects of the disclosure, using multiple perforated graphene sheets; and

FIG. 7 is a simplified diagram illustrating a plumbing arrangement corresponding generally to the arrangement of FIG. 6, in which the perforated graphene sheets are spirally wound and enclosed in cylinders.

### DETAILED DESCRIPTION

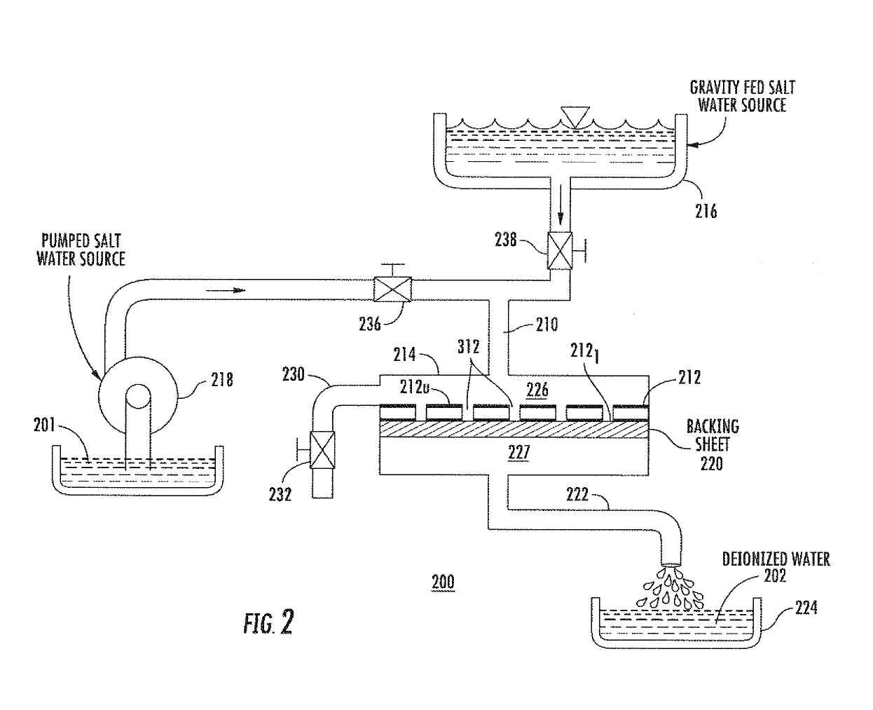

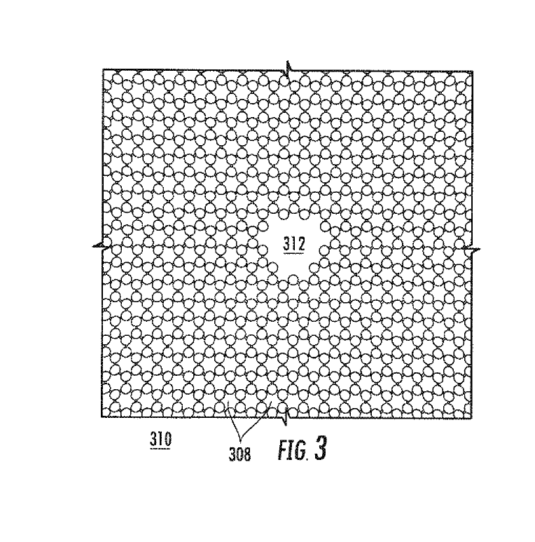

FIG. 2 is a notional representation of a basic deionization apparatus 200 according to an exemplary embodiment or aspect of the disclosure. In FIG. 2, a channel 210 conveys ion-laden water to a filter membrane 212 mounted in a supporting chamber 214. The ion-laden water may be, for example, seawater or brackish water. In one exemplary embodiment, the filter membrane 212 can be wound into a spiral in known manner. Flow impetus or pressure of the ion-laden water flowing through channel 210 of FIG. 2 can be provided either by gravity from a tank 216 or from a pump 218. Valves 236 and 238 allow selection of the source of ion-laden water. In apparatus or arrangement 200, filter membrane 212 is a perforated graphene sheet with perforations also termed apertures. Graphene is a single-atomic-layer-thick layer of carbon atoms, bound together to define a sheet 310, as illustrated in FIG. 3. The thickness of a single graphene sheet is approximately 2 nanometers (nm). Multiple graphene sheets can be formed, having greater thickness. The carbon atoms of the graphene sheet 310 of FIG. 3 define a repeating pattern of hexagonal ring structures (benzene rings) constructed of six carbon atoms, which form a honeycomb lattice of carbon atoms. An interstitial aperture 308 is formed by each six carbon atom ring structure in the sheet and this interstitial aperture is less than one nanometer across. This dimension is much too small to allow the passage of either water or ions.

The deionization apparatus of FIG. 2 has a solution flow path from the water sources 201 or 216 to channel 210, which may be considered an input to the solution flow path. From channel 210, the solution flow path continues to the solution flow path input side of chamber 214, then through graphene sheet 212, then to the solution flow path output side of chamber 214, and finally to channel 222, which may be considered an output to the solution flow path. Water carrying unwanted ions 201 may be pressurized by pump 218 or by gravity feed from tank 216 to thereby generate pressurized water. The pressurized water is applied to a first side 212u of the perforated graphene 212, so that water molecules flow to a second side 2121 of the perforated graphene sheet.

In order to form the perforated graphene sheet 212 of FIG. 2, one or more perforations are made, as illustrated in FIG. 3. A representative generally or nominally round aperture 312 is defined through the graphene sheet 310. In an embodiment, Aperture 312 has a nominal diameter of about two nanometers. The two-nanometer dimension is selected to allow the transit through the aperture of the largest of the ions which would ordinarily be expected in salt or brackish water, which is the chlorine ion. However, functionalization of the perimeter of the aperture, described in detail herein, is relied upon to repel the ions from transiting the aperture, even though the aperture is otherwise sized to allow transit of the ions. The generally round shape of the aperture 312 is affected by the fact that the edges of the aperture are defined, in part, by the hexagonal carbon ring structure of the graphene sheet 310.

Aperture 312 may be made by selective oxidation, by which is meant exposure to an oxidizing agent for a selected period of time. It is believed that the aperture 312 can also be laser-drilled. As described in the publication Nano Lett. 2008, Vol. 8, no. 7, pg 1965-1970, the most straightforward perforation strategy is to treat the graphene film with dilute oxygen in argon at elevated temperature. As described therein, through apertures or holes in the 20 to 180 nm range were etched in graphene using 350 mTorr of oxygen in 1 atmosphere (atm) argon at 500° C. for 2 hours. The paper reasonably suggests that the number of holes is related to defects in the graphene sheet and the size of the holes is related to the residence time. This is believed to be the preferred method for making the desired perforations in graphene structures. The structures may be graphene nanoplatelets and graphene nanoribbons. Thus, apertures in the desired range can be formed by shorter oxidation times. Another more involved method utilizes a self assembling polymer that creates a mask suitable for patterning using reactive ion etching. A P(S-blockMMA) block copolymer forms an array of PMMA columns that form vias for the RIE upon redeveloping. The pattern of holes is very dense. The number and size of holes is controlled by the molecular weight of the PMMA block and the weight fraction of the PMMA in the P(S-MMA). Either method has the potential to produce perforated graphene sheets.

The perimeters of the apertures may be functionalized with a specifically charged functional group. The charged group around the perimeter will repel ions of similar charge, increasing the activation barrier for the similarly charged ions to transit the aperture. In addition, ions of an opposite charge will be influenced to stay with the non-transiting ions. Separation of positive and negative ions would require a large amount of energy to be input into the system, which is not a feature of the invention. Thus, by repelling ions of a similar charge from transiting the functionalized apertures, ions of an opposite charge are also effectively repelled from transiting the functionalized apertures. In an embodiment, the perimeter of the apertures may be functionalized with oxygen, which is a negatively charged ion. A sheet with apertures functionalized with oxygen will repel chlorine ions, which are negatively charged, which will cause the chlorine ions to transit the apertures at a greatly reduced rate or not at all. Sodium ions, which are positively charged, will be influenced to stay within chamber 226 with the repelled chlorine ions. In other embodiments, perimeters of the apertures may be functionalized with a negative charge using elements other than oxygen. For example, in an embodiment at least one of nitrogen, phosphorous, sulfur, fluorine, chlorine, bromine, and iodine may be used to functionalize with perimeters with a negative charge.

Thus, if the perimeters of the apertures of sheet 212 are charged to repel ions of one charge, ions of an opposite charge may also be influenced to not transit the sheet. While it may be possible to cause the ions of an opposite charge to transit the apertures of the sheet by inputting a large amount of energy into the system, it is anticipated that adding this amount of energy to the system would create a reaction (e.g., such as the production of chlorine gas or hydrogen gas) that would not be desirable in the context of deionization.

As will be understood, in another embodiment, the perimeters may be charged with a positively charged ion such as boron. A sheet with apertures functionalized with boron will cause positively charged sodium ions to transit the apertures at a greatly reduced rate or not at all. Negatively charged chlorine ions will be inclined to stay with the sodium ions and will also transit the apertures at a greatly reduced rate or not at all. In other embodiments, perimeters of the apertures may be functionalized with a positive charge using elements other than boron. For example, in an embodiment at least one of hydrogen, lithium, magnesium, and aluminum may be used to functionalize with perimeters with a positive charge.

In another embodiment, the perimeters of the apertures may be functionalized with polymer or amino acid chains that have an overall positive or negative charge. Some candidate polymers include polyethylene oxide, polysulfonimide class polymers, gold-thiol inlays, ruthenium-based organometallics, and electrolytic polymers. The use of a polymer or amino acid chain may allow more control over the strength of the charge on the perimeters of the apertures, thereby allowing a degree of control over the repelling and/or attracting effects of the functionalized apertures. The strength of charge may be important depending on the types of ions that are sought to be filtered by the graphene sheet.

Functionalization of the apertures may be achieved by a variety of generally known methods. In an embodiment, functionalized apertures on a graphene sheet may be created by seeding the graphene sheet with a chemical or radical that is reactive to oxygen, and then exposing the sheet to oxygen plasma thereby causing the chemical or radical to react and create functionalized holes in the graphene sheet. In another embodiment, the functionalized apertures may be formed by applying a chemical functional group that is reactive to an external stimuli such as an electrical charge or light pulses to the perimeter of existing apertures, and then exposing the sheet to the charge or light pulses and thereby causing the chemical group to attach to the perimeters. Acid treatment, reactive-ion etching, or standard organic chemistry techniques may also be used to functionalize the perimeters of the apertures. The methods of functionalization include but are not limited to: Reactive ions and molecular species like carbon tetrafluoride plasma, oxygen plasma, atomic oxygen, nitrogen plasma and atomic nitrogen. Functionalization of the material after initial creation of defects in the structure depends on the chemical constituents left on the material: for example if a nitrogen or oxygen reactive group is attached to the material the material could be reacted with an organic acid chloride to create an ester or amide linkage between the material and a functional group. The functional group attached to the material could be anything that would support the linker functionality.

As mentioned, the graphene sheet 310 of FIG. 3 has a thickness of but a single atom. Thus, the sheet tends to be flexible. The flex of the graphene sheet can be ameliorated by applying a backing structure to the sheet 212. In FIG. 2, the backing structure of perforated graphene sheet 212 is illustrated as 220. Backing structure 220 in this embodiment is a sheet of perforated polytetrafluoroethylene, sometimes known as polytetrafluoroethane. A thickness of the backing sheet may be, for example, one millimeter (mm).

It should be noted that, in the apparatus or arrangement of FIG. 2, the pressure of ion-laden water applied through path 210 to the perforated membrane 212 can be provided by gravity from tank 216, thereby emphasizing one of the aspects of the apparatus 200. That is, unlike the RO membrane, the perforated graphene sheet 310 (FIG. 3) forming the perforated membrane is hydrophobic, and the water passing through the pierced apertures (312 of FIGS. 2 and 3) is not impeded by the attractive forces attributable to wetting. Also, as mentioned, the length of the flow path through the apertures 312 in graphene sheet 310 is equal to the thickness of the sheet, which is about 2 nm. This length is much less than the lengths of the random paths extending through a RO membrane. Consequently, very little pressure is required to provide fluid flow, or conversely, the flow at a given pressure is much greater in the perforated graphene sheet 310. This, in turn, translates to a low energy requirement for ion separation. It is believed that the pressure required in a RO membrane to force water through the membrane against osmotic pressure includes a frictional component which results in heating of the membrane. Consequently, some of the pressure which must be applied to the RO membrane does not go toward overcoming osmotic pressure, but instead goes into heat. Simulated results show that the perforated graphene sheet reduces the required pressure by at least a factor of five. Thus, where an RO membrane might require forty pounds per square inch (PSI) of pressure on the upstream side to effect a particular flow of deionized water at a particular ion concentration, a perforated graphene sheet for the same flow rate may require eight PSI or less.

As mentioned, the perforations 312 in graphene sheet 212 of FIG. 2 (or equivalently graphene sheet 310 of FIG. 3) may be functionalized to effectively block ions of a certain charge from transiting the graphene sheet. As further mentioned, ions of a charge opposite to the certain charge may also be effectively blocked, because the ions of an opposite charge will tend to stay with the blocked ions of a certain charge absent the input of large amounts of energy. Consequently, any ions that are not expected to pass through graphene sheet can be expected to accumulate in an upstream side 226 of the graphene-sheet-supporting chamber 214. The accumulation of ions in upstream “chamber” 226 is referred to herein as “condensate,” and will eventually reduce the flow of water through the perforated graphene sheet 212, thereby tending to render it ineffective for deionization. As illustrated in FIG. 2, a further path 230 is provided, together with a discharge valve 232, to allow purging or discharge of the condensate.

Operation of the apparatus or arrangement 200 of FIG. 2 may be in a “batch” mode. The first mode of the batch operation occurs with flow of ion-laden water through path 210, with discharge valve 232 closed to prevent flow. Ion-laden water fills the upstream side 226 of the support chamber 214. The water molecules are allowed to flow through perforated graphene sheet 212 of FIG. 2 and through the backing sheet 220 to the downstream side 227 of the support chamber 214. Ions (both positively and negatively charged) accumulate in the upstream side 226 and deionized water accumulates in downstream portion 227, and is available to be drawn off through a path 222 to a capture vessel illustrated as a tank 224. The flow of water molecules may continue until a threshold level of condensate accumulates in the upstream chamber 226. At that point, a purge of the upstream ions may be performed through path 230 using discharge valve 232.

By way of example, the perimeters of the perforations (apertures) 312 in graphene sheet 212 of FIG. 2 may be functionalized to have a negative charge. This may be achieved by functionalizing the perimeter using oxygen, nitrogen, phosphorous, sulfur, fluorine, chlorine, bromine, or iodine. Alternatively, this may be achieved by functionalizing the perimeter using a polymer or amino acid change having an overall negative charge. Consequently, any negatively charged ions in the solution will be repelled from transiting the apertures 312, and will collect in the upstream chamber 226. In addition, positively charged ions in the solution will be attracted to remain with the negatively charged ions collecting in upstream chamber 226, and will also not transit the apertures 312. Deionized water will pass through the apertures and collect in downstream chamber 227. The positively and negatively charged ions in the upstream chamber may be purged by a batch process as described. In an alternate embodiment, the perimeters of the perforations (or apertures) 312 in graphene sheet 212 of FIG. 2 may be functionalized to have a positive charge. This may be achieved by functionalizing the perimeter using boron, hydrogen, lithium, magnesium, or aluminum. Alternatively, this may be achieved by functionalizing the perimeter using a polymer or amino acid change having an overall positive charge. Consequently, any positively charged ions in the solution will be repelled from transiting the apertures 312, and will collect in the upstream chamber 226. In addition, negatively charged ions in the solution will be attracted to remain with the positively charged ions collecting in upstream chamber 226, and will also not transit the apertures 312. Deionized water will pass through the apertures and collect in downstream chamber 227. The positively and negatively charged ions in the upstream chamber may be purged by a batch process as described.

In addition to the apertures of the graphene sheet being functionalized to attract or repel certain ions, in an embodiment the apertures may also be dimensioned or sized to disallow ions of a certain size from passing. For example, graphene sheet 212 may be perforated by apertures 312 dimensioned to disallow or disable the flow of chlorine ions; these apertures are 1.3 nm to 2 nm in nominal diameter. Thus, if the apertures are dimensioned to be 1.3 nm to 2 nm, chlorine ions cannot pass through perforated graphene sheet 212 and remain in the upstream portion or chamber 226. (The chlorine ions are also repelled from the apertures by the functionalization of the perimeters.) In addition, positively charged sodium ions in the solution will be influenced to remain with the negatively charged chlorine ions collecting in upstream chamber 226, and will also not transit the apertures 312. Deionized water will pass through the apertures and collect in downstream chamber 227. Sizing the apertures to filter ions in combination with functionalizing the apertures of the graphene sheet can result in increased efficiency of the deionization process. A more detailed description of a method and system for deionization using charged graphene sheets with different aperture sizes is disclosed in copending U.S. patent application Ser. No. 12/868,150 (Attorney Docket No. BA-11041), which is fully incorporated by reference herein.

In another embodiment, in addition to the apertures of the graphene sheet being functionalized to attract or repel certain ions, the entire graphene sheet may be charged, adding to the sheets repulsion of similarly charged ions. For example, a graphene sheet that has apertures functionalized with negatively charged ion such as oxygen, may also be connected to a voltage source so that a negative charge is placed upon the entire sheet. Chlorine ions, having a negative charge, are repelled from transiting through the negatively charged perforated graphene sheet 212, and remain in the upstream portion or chamber 226. In addition, positively charged sodium ions in the solution will be influenced to remain with the negatively charged chlorine ions collecting in upstream chamber 226, and will also not transit the apertures 312. Deionized water will pass through the apertures and collect in downstream chamber 227.

As will be understood, the additional methods of encouraging ion repulsion, using apertures of differing size and charging the graphene sheets, may be combined in different ways with the use of functionalized apertures. Thus, one embodiment may use functionalized apertures and apertures of differing size, while another embodiment may use functionalized apertures and charged graphene sheets. Yet another embodiment may use all three methods at once, functionalization, differing aperture sizes, and charged graphene sheets.

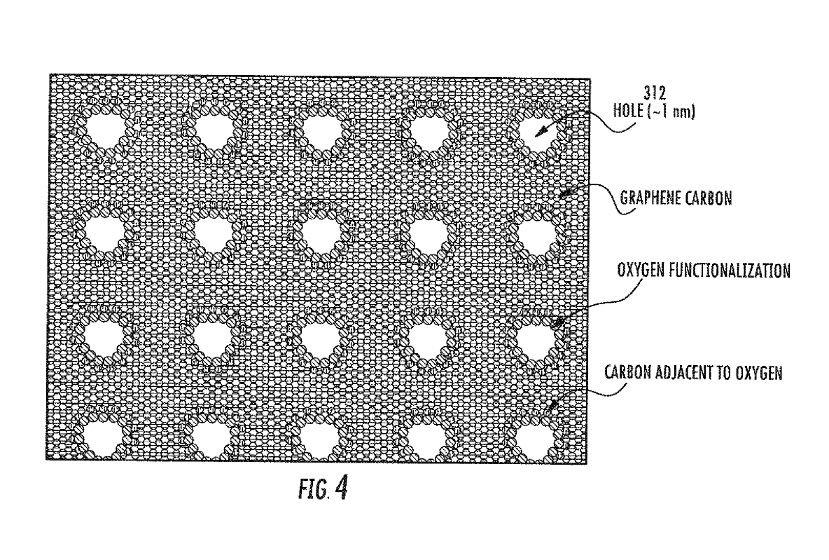

FIG. 4 is a representation of a graphene sheet with a plurality of perforations such as that of FIG. 3. The sheet of FIG. 4 defines twenty apertures 312. In principle, the flow rate will be proportional to the aperture density. As the aperture density increases, the flow through the apertures may become “turbulent,” which may adversely affect the flow at a given pressure. Also, as the aperture density increases, the strength of the underlying graphene sheet may be locally reduced. Such a reduction in strength may, under some circumstances, result in rupture of the membrane. The center-to-center spacing between apertures is believed to be near optimum for the six-nanometer apertures at a value of fifteen nanometers. In the embodiment of FIG. 4, the perimeters of the apertures 312 are functionalized with oxygen, although as described elsewhere herein the perimeters may be charged with other elements or with polymer or amino acid chains. Carbon is adjacent to the oxygen functionalization as shown.

The apertures shown in FIG. 4 are functionalized around the perimeters of the perforations or apertures. In the embodiment shown in FIG. 4, the perimeters of the apertures are functionalized with oxygen, nitrogen, phosphorous, sulfur, fluorine, chlorine, bromine, or iodine, which results in the perimeter having a negative charge. In another embodiment (not shown), the perimeters of the apertures are functionalized with boron, hydrogen, lithium, magnesium, or aluminum, which results in the perimeter having a positive charge. The perimeters of the apertures may alternatively be functionalized with polymer chains or amino acid chains, with the perimeter having a charge that depends on the specific polymer or amino acid used.

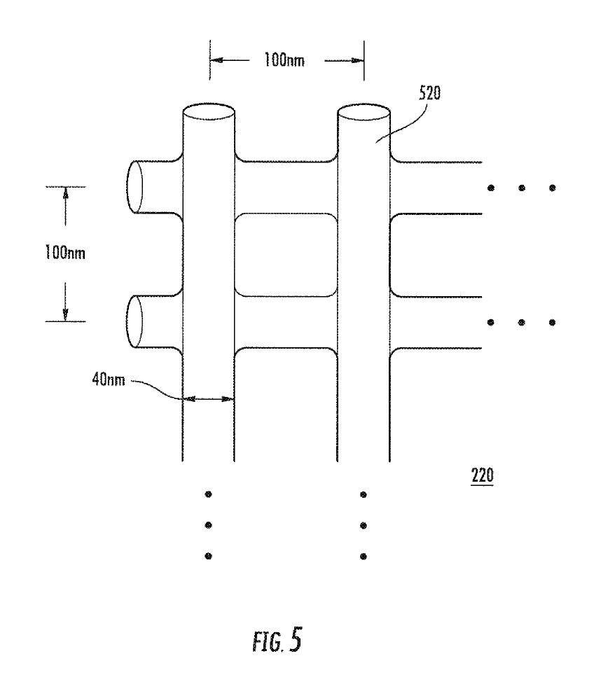

FIG. 5 is a simplified illustration of the structure of a backing sheet which may be used with the graphene sheet of FIG. 2. In FIG. 5, backing sheet 220 is made from filaments 520 of polytetrafluoroethylene, also known as polytetrafluoroethane, arranged in a rectangular grid and bonded or fused at their intersections. As with the perforated graphene sheet, the dimensions in the backing sheet should be as large as possible for maximum flow, commensurate with sufficient strength. The spacing between mutually adjacent filaments 520 oriented in the same direction can be nominally 100 nm, and the filaments may have a nominal diameter of 40 nm. The tensile strength of the graphene sheet is great, and so the relatively large unsupported areas in the backing sheet should not present problems.

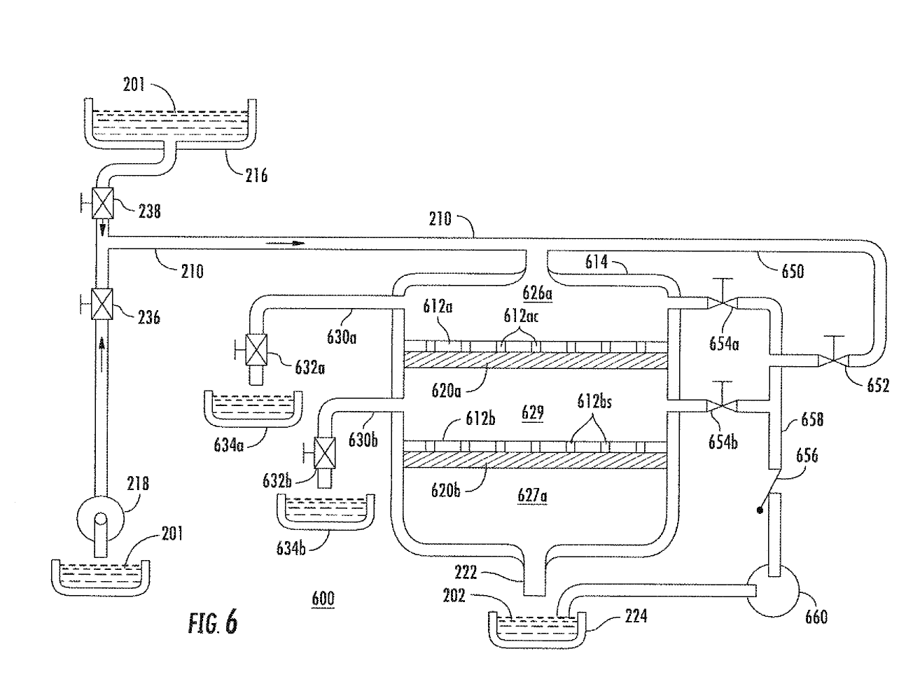

FIG. 6 is a notional illustration of a deionization or desalination apparatus 600 (i.e., a solution deionizer) according to another embodiment or aspect of the disclosure, in which multiple layers of differently-functionalized graphene sheets are used. In FIG. 6, elements corresponding to those of FIG. 2 are designated by like reference alphanumerics. Within support chamber 614 of FIG. 6, upstream and downstream perforated graphene sheets 612a and 612b, respectively, divide the chamber into three volumes or portions, namely an upstream portion or chamber 626a, a downstream portion or chamber 627a, and an intermediate portion or chamber 629. As used herein, the terms upstream and downstream convey the relation of parts of the apparatus in relation to other parts, in terms of the flow of the water in the apparatus, which is from the input channel 210 to the first graphene sheet 612a, then from the first graphene sheet 612a to the second graphene sheet 612b, and then from the second graphene sheet to the output channel 222. Thus, while perforated graphene sheet 612a is upstream in relation to the downstream graphene sheet 612b, perforated graphene sheet 612a is downstream in relation to the input channel 210. Notably, the term downstream is not intended to necessarily imply an elevation relationship between elements; that is, while the second graphene sheet 612b may be downstream from first graphene sheet 612a, that does not necessarily mean that second graphene sheet 612b is at a lower elevation than first graphene sheet 612a, though it may be. As will be understood, the apparatus may be pressurized so that a downstream element may be downstream in terms of flow but may be higher in elevation than an upstream element.

Specifically, the solution or water deionizer apparatus of FIG. 6 has a solution flow path from the water 201 from vessel or container 216 or pump 218 to channel 210, which may be considered an input to the solution flow path. From channel 210, the solution flow path continues to upstream chamber 626a of chamber 614, through graphene sheet 612a, through intermediate chamber 629, though graphene sheet 612b, then to downstream chamber 627a, and finally to channel 222, which may be considered an output to the solution flow path.

Each perforated graphene sheet 612a and 612b is associated with a backing sheet. More particularly, perforated graphene sheet 612a is backed by a sheet 620a, and perforated graphene sheet 612b is backed by a sheet 620b. As noted, graphene is a single-atomic-layer-thick layer of carbon atoms, bound together to define a sheet 310, as illustrated in FIG. 3. As also noted, the flex of the graphene sheet can be ameliorated by applying a backing structure to the sheet.

More particularly, in an embodiment, upstream graphene sheet 612a is functionalized with negatively charged perimeters of apertures 612ac to repel chlorine ions from transiting the aperture. Chlorine ions, having a negative charge, may be repelled from passing through the negatively charged perimeters of graphene sheet 612a, and therefore remain in the upstream portion or chamber 626a. However, as will be understood, the presence of the repelled chlorine ions on the input side of the sheet 612a will influence the sodium ions to also remain on the input side. As noted, separation of the chlorine and sodium ions would require a large amount of energy to be input into the system, which is not a feature of the invention. Thus, by repelling the chlorine ions from transiting the graphene sheet, sodium ions are also effectively repelled from transiting the upstream graphene sheet.

There may be situations in which some of the sodium ions may nevertheless transit the apertures of the upstream graphene sheet. For example, if the input solution has an excess of sodium ions in relation to chlorine ions, the excess sodium ions may be attracted to transit the apertures by the positive charge on the graphene sheet. In another example, the input solution may contain a third ion which is positively charged and which is not sodium, which may be attracted to transit through the upstream graphene sheet apertures. In these situations, it may be desirable to have a second graphene sheets to filter ions. In addition, it may be desirable to have a second graphene sheet to ensure a higher level of desalination.

Thus, the embodiment of FIG. 6 includes downstream graphene sheet 612b, which is perforated with apertures 612bs (second apertures) and may be positively charged to repel the transit of sodium ions (or any other positive charged ion) through graphene sheet 612b. If sodium or other positive ions were able to transit through sheet 612a into chamber 629, they are repelled from transiting through downstream positively charged perforated graphene sheet 612b, and so remain or accumulate in intermediate portion or chamber 629. In addition, to the extent that any chlorine ions were able to transit into chamber 629, those chlorine ions may be attracted to stay with the sodium ions in 629, and also will not transit through sheet 612b. Thus, water molecules (H₂O) substantially free of at least chlorine and sodium ions can flow from intermediate portion or chamber 629 through apertures 612bs of perforated graphene sheet 612b and into downstream portion or chamber 627a, from whence the deionized water can be collected through water flow path 222 and collection vessel 224. Water flow path 222 may be considered the water flow path output, and a valve (not shown) may be implemented as a water flow path output valve on the water flow path output 222. As will be understood, an alternate embodiment in which the upstream graphene sheet 612a has positively charged apertures and downstream graphene sheet 612b has negatively charged apertures will operate similarly.

Thus, while it is anticipated that a single graphene sheet deionizer as shown in FIG. 2 may, if properly “tuned,” produce sufficiently deionized water, a two graphene sheet deionizer as shown in FIG. 6 provides an extra layer that may be capable of meeting the highest deionization standards. As will be understood, the second graphene sheet may alternatively be functionalized to repel different types of ions. In addition, systems employing more than two graphene sheets may be used to ensure filtration of different types of ions and to ensure that the deionized water meets the highest standards.

As with the case of the deionization arrangement 200 of FIG. 2, the apparatus or arrangement 600 of FIG. 6 accumulates or concentrates ions during deionization operation. More particularly, with a flow of water laden with chlorine and sodium ions, it is anticipated that most of the chlorine and sodium ions will be repelled by the upstream graphene sheet 612a, resulting in upstream portion or chamber 626a of apparatus 600 accumulating a condensate concentration with both chlorine and sodium ions. Intermediate portion or chamber 629 also accumulates a concentration of chlorine and sodium ions, although it is anticipated that the concentration will be far lower than the concentration accumulated in the upstream chamber. These concentrated ions can be separately extracted by selective control of purging connections 630a and 630b and their purge valves 632a and 632b, respectively. More particularly, valve 632a can be opened to allow the concentrated chlorine and sodium ions to flow from upstream portion or chamber 626a to a collecting vessel illustrated as a tank 634a, and valve 632b can be opened to allow the concentrated chlorine and sodium ions to flow from intermediate portion or chamber 629 to a collecting vessel illustrated as a tank 634b. Ideally, purge valve 632a is closed before purging of intermediate portion or tank 629 is begun, so that some pressure is maintained across perforated graphene sheet 612a to provide a flow of water through perforated graphene sheet 612a to aid in flushing the sodium-ion-rich condensate from the intermediate chamber 629. Purge valves 632a and 632b are closed prior to proceeding with the deionization. The purged and collected concentrated ions may have economic value, as for conversion into solid form in the case of sodium or gaseous form in the case of chlorine. It should be noted that sea water contains significant amounts of beryllium salts, and these salts, if preferentially concentrated, have value to the pharmaceutical industry as a catalyst. As will be understood, an alternate embodiment in which the upstream graphene sheet 612a is functionalized with positively charged perimeters of apertures 612ac and downstream graphene sheet 612b is functionalized with negatively charged perimeters 612bs will operate similarly, with most of the ions accumulating in the upstream chamber 626a and a far lower concentration of ions accumulating in intermediate chamber 629. Those accumulated ions can be purged as described above.

Also illustrated in FIG. 6 are cross-flow valves 654a and 654b, communicating between a flow path 658 and upstream portion or chamber 626a and intermediate portion or chamber 629, respectively. Unfiltered water 201 loaded with ions can be routed to flow path 658 by opening valve 652, or deionized water 202 can be provided from tank 224 by operating a pump 660. From pump 660, the deionized water flows through a check valve 656 to path 658. Cross-flow valves 654a and 654b are opened and closed simultaneously with purge valves 632a and 632b, respectively, to thereby aid in purging the condensate from the chambers.

As discussed, the graphene sheets in the deionizer may be dimensioned to disallow the passage or transit of ions of a certain size, in addition to the apertures of the graphene sheet being functionalized to repel certain ions. For example, the perforations may be sized to disallow the passage of chlorine ions by selecting an aperture size of approximately 1.3 nm to 2 nm. Alternatively, perforations may be sized to disallow the passage of sodium ions by selecting an aperture size of approximately 1.3 nanometers. Sizing the apertures to filter ions in combination with functionalizing the apertures of the graphene sheet can result in increased efficiency of the deionization process.

In an embodiment, the size of the perforations on graphene sheets 612a and 612b differ in size so that one sheet effectively disallows the flow of water laden with chlorine and one sheet effectively disallows the flow of water laden with sodium. In an embodiment including perforations of different size as well as functionalization of the apertures, deionization is effected by both. By way of example, upstream graphene sheet 612a is perforated by apertures 612ac dimensioned to disallow or disable the flow of chlorine ions; these apertures are 1.3 nm to 2 nm in nominal diameter. Thus, chlorine ions cannot pass through perforated graphene sheet 612a, but remain in the upstream portion or chamber 626a. Sodium ions are also indirectly repelled from flowing through perforated graphene sheet 612a into intermediate chamber 629 because the sodium ions will tend to stay with the repelled chlorine ions to prevent a charge build up. Downstream perforated graphene sheet 612b is perforated with apertures 612bs dimensioned to disallow or disable the flow of sodium ions; these apertures are 1.3 nanometers in nominal diameter. Water molecules (H₂O) free of at least chlorine and sodium ions can flow from intermediate portion or chamber 629 through apertures 612bs of perforated graphene sheet 612b and into downstream portion or chamber 627a, from whence the deionized water can be collected through path 222 and collection vessel 224.

As also discussed in relation to the deionizer, in addition to the apertures of the graphene sheets being functionalized to attract or repel certain ions, a charge may be applied to each of the graphene sheets, adding to each sheet's attraction of oppositely charged ions and repulsion of similarly charged ions. For example, in addition to having functionalized apertures, upstream graphene sheet 612a may be negatively charged, which causes it to repel chlorine ions from transiting the apertures 612ac. Chlorine ions, having a negative charge, remain in the upstream portion or chamber 626a because they are repelled by both the functionalized apertures 612ac and the negative charge on sheet 612a. In addition, positively charged sodium ions will also tend to remain in the upstream chamber 626a with the chlorine ions. Although a substantial concentration of the chlorine and sodium ions will be repelled (either directly or indirectly) by the functionalization and charge of the graphene sheet 612a, as noted in relation to the embodiment having only functionalized apertures, it is possible that some chlorine, sodium, or other ions may nevertheless transit apertures 612ac. If this occurs, downstream perforated graphene sheet 612b is perforated with apertures 612bs and, in addition to having positively functionalized apertures, is positively charged. This positive charge repels the transit of sodium ions through graphene sheet 612b, and also indirectly repels the transit of any chlorine ions that may have made it to intermediate chamber 629. Water molecules (H₂O) free of at least chlorine and sodium ions (deionized water) can flow from intermediate portion or chamber 629 through apertures 612bs of perforated graphene sheet 612b and into downstream portion or chamber 627a, from whence the deionized water can be collected through path 222 and collection vessel 224. An alternate embodiment in which a positive charge is applied to the upstream graphene sheet 612a (in which sheet 612a also has positively charged functionalized apertures 612ac) and a negative charge is applied to downstream graphene sheet 612b (in which sheet 612b also has negatively charged functionalized apertures 612bs) will operate similarly.

As will be understood, the additional methods of ion repulsion, using apertures of differing size and charging the graphene sheets, may be combined in different ways with the use of functionalized apertures. Thus, one embodiment may use functionalized apertures and apertures of differing size, while another embodiment may use functionalized apertures and charged graphene sheets. Yet another embodiment may use all three methods at once, functionalization, differing aperture sizes, and charged graphene sheets.

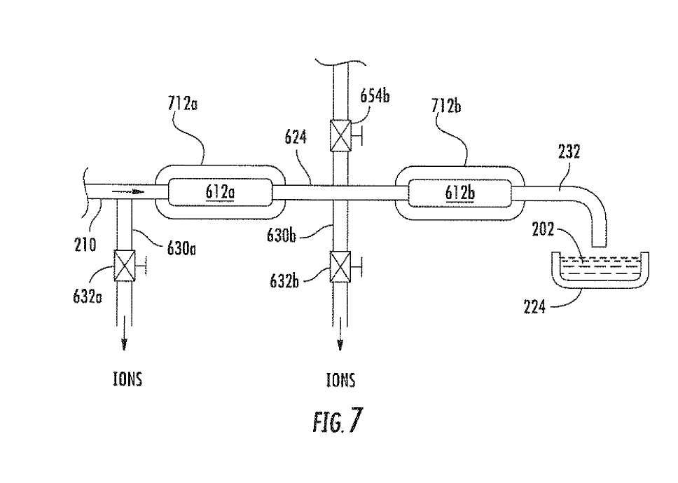

FIG. 7 is a simplified representation of a deionizing arrangement according to an aspect of the disclosure. Elements of FIG. 7 corresponding to those of FIG. 6 are designated by like reference alphanumerics. In FIG. 7, the perforated graphene sheets 612a and 612b are rolled or spiral-wound into cylindrical form, and inserted into housings illustrated as 712a and 712b, respectively, as know from the RO membrane arts.

Those skilled in the art will understand that ions other than chlorine and sodium may be removed from water by selective functionalization of the apertures on a graphene sheet or sheets.

A method for deionization of a solution comprises the steps of functionalizing plural apertures of a graphene sheet to repel first ions in the solution from transit through the functionalized plural apertures, the non-transiting first ions influencing second ions in the solution to not transit through the functionalized plural apertures; positioning the graphene sheet in between a solution flow path input and a solution flow path output; causing a solution to enter the solution flow path input and through the functionalized plural apertures of the graphene sheet, thereby resulting in a deionized solution on the solution flow path output side of the graphene sheet and a second solution containing the first and second ions on the solution flow path input side of the graphene sheet.

A method for deionization of a solution comprises the steps of functionalizing first plural apertures of a first graphene sheet to repel first ions in the solution from transit through the functionalized first plural apertures, the non-transiting first ions also influencing second ions in the solution to not transit through the functionalized first plural apertures, functionalizing second plural apertures of a second graphene sheet to repel second ions in the solution, the non-transiting second ions also influencing first ions in the solution to not transit through the functionalized second plural apertures; positioning the first graphene sheet downstream of a solution flow path input and positioning the second graphene sheet between the first graphene sheet and a solution flow path output; and causing solution to enter the solution flow path input, through said first graphene sheet, then through said second graphene sheet, thereby resulting in a deionized solution at the solution flow path output.

What is claimed is:

1. A method for deionization of a solution, said method comprising the steps of:
functionalizing plural apertures of a graphene sheet to repel first ions in the solution from transit through the functionalized plural apertures, the non-transiting first ions influencing second ions in the solution to not transit through the functionalized plural apertures;
positioning the graphene sheet in between a solution flow path input and a solution flow path output; and
causing a solution to enter the solution flow path input and through the functionalized plural apertures of the graphene sheet, thereby resulting in a deionized solution on the solution flow path output side of the graphene sheet and a second solution containing the first ions and second ions on the solution flow path input side of the graphene sheet.

2. The method for deionization of claim 1, wherein
the first ions are negatively charged ions;
the second ions are positively charged ions; and
functionalizing the plural apertures comprises functionalizing perimeters of the plural apertures to have a negative charge to repel the negatively charged ions in the solution.

3. The method for deionization of claim 2, wherein functionalizing the perimeters of the plural apertures to have a negative charge comprises functionalizing the perimeters using oxygen, nitrogen, phosphorous, sulfur, fluorine, chlorine, bromine, or iodine.

4. The method for deionization of claim 2, wherein functionalizing the perimeters of the plural apertures to have a negative charge comprises functionalizing the perimeters using polymer chains or amino acid chains having an overall negative charge.

5. The method for deionization of claim 1, wherein
the first ions are positively charged ions;
the second ions are negatively charged ions; and
functionalizing the plural apertures comprises functionalizing perimeters of the plural apertures to have a positive charge to repel positively charged ions in the solution.

6. The method for deionization of claim 5, wherein functionalizing perimeters of the plural apertures to have a positive charge comprises functionalizing the perimeters using boron, hydrogen, lithium, magnesium, or aluminum.

7. The method for deionization of claim 5, wherein functionalizing perimeters of the plural apertures to have a positive charge comprises functionalizing the perimeters using polymer chains or amino acid chains having an overall positive charge.

8. The method for deionization of claim 1, further comprising dimensioning the plural apertures of the graphene sheet to repel the transit of the first ions.

9. The method for deionization of claim 1, further comprising applying an electrical charge to the graphene sheet, wherein the electrical charge repels the first ions.

10. The method for deionization of claim 9, further comprising dimensioning the plural apertures of the graphene sheet to repel the transit of the first ions.

11. A method for deionization of a solution, said method comprising the steps of:
functionalizing first plural apertures of a first graphene sheet to repel first ions in the solution from transit through the functionalized first plural apertures, the non-transiting first ions also influencing second ions in the solution to not transit through the functionalized first plural apertures;
functionalizing second plural apertures of a second graphene sheet to repel second ions in the solution from transit through the functionalized second plural apertures, the non-transiting second ions also influencing first ions in the solution to not transit through the functionalized second plural apertures;
positioning the first graphene sheet downstream of a solution flow path input and positioning the second graphene sheet between the first graphene sheet and a solution flow path output; and
causing solution to enter the solution flow path input, through said first graphene sheet, then through said second graphene sheet, thereby resulting in a deionized solution at the solution flow path output.

12. The method for deionization of claim 11, wherein
the first ions are negatively charged ions;
the second ions are positively charged ions;
functionalizing the first plural apertures comprises functionalizing first perimeters of the first plural apertures to have a negative charge to repel the negatively charged ions in the solution; and
functionalizing the second plural apertures comprises functionalizing second perimeters of the second plural apertures to have a positive charge to repel the positively charged ions in the solution.

13. The method for deionization of claim 12, wherein functionalizing the first perimeters of the first plural apertures to have a negative charge comprises functionalizing the first perimeters using oxygen, nitrogen, phosphorous, sulfur, fluorine, chlorine, bromine, or iodine.

14. The method for deionization of claim 12, wherein functionalizing the first perimeters of the first plural apertures to have a negative charge comprises functionalizing the first perimeters using polymer chains or amino acid chains having an overall negative charge.

15. The method for deionization of claim 12, wherein functionalizing second perimeters of the second plural apertures to have a positive charge comprises functionalizing the second perimeters using boron, hydrogen, lithium, magnesium, or aluminum.

16. The method for deionization of claim 12, wherein functionalizing second perimeters of the second plural apertures to have a positive charge comprises functionalizing the second perimeters using polymer chains or amino acid chains having an overall positive charge.

17. The method for deionization of claim 11, wherein
the first ions are positively charged ions;
the second ions are negatively charged ions;
functionalizing the first plural apertures comprises functionalizing first perimeters of the first plural apertures to have a positive charge to repel the positively charged ions in the solution; and
functionalizing the second apertures comprises functionalizing second perimeters of the second plural apertures to have a negative charge to repel the negatively charged ions in the solution.

18. The method for deionization of claim 17, wherein functionalizing second perimeters of the second plural apertures to have a negative charge comprises functionalizing the second perimeters using oxygen, nitrogen, phosphorous, sulfur, fluorine, chlorine, bromine, or iodine.

19. The method for deionization of claim 17, wherein functionalizing the second perimeters of the second plural apertures to have a negative charge comprises functionalizing the second perimeters using polymer chains or amino acid chains having an overall negative charge.

20. The method for deionization of claim 17, wherein functionalizing first perimeters of the first plural apertures to have a positive charge comprises functionalizing the first perimeters using boron, hydrogen, lithium, magnesium, or aluminum.

21. The method for deionization of claim 12, wherein functionalizing first perimeters of the first plural apertures to have a positive charge comprises functionalizing the first perimeters using polymer chains or amino acid chains having an overall positive charge.

22. The method for deionization of claim 11, further comprising dimensioning the first plural apertures of the first graphene sheet to repel the transit of the first ions and dimensioning the second plural apertures of the second graphene sheet to repel the transit of the second ions.

23. The method for deionization of claim 11, further comprising applying a first electrical charge to the first graphene sheet and a second electrical charge to the second graphene sheet, wherein said first electrical charge repels the first ions and said second electrical charge repels the second ions.

24. The method for deionization of claim 23, further comprising dimensioning the first plural apertures of the first graphene sheet to repel the transit of the first ions and dimensioning the second plural apertures of the second graphene sheet to repel the transit of the second ions.

25. A deionizer, comprising:
a graphene sheet with plural apertures functionalized to repel first ions in a solution from transit through the plural apertures, the non-transiting first ions influencing second ions in the solution to not transit through the functionalized plural apertures;
a solution flow path with an input and an output, wherein the graphene sheet is positioned between the solution flow path input and the solution flow path output; and
a source of solution laden with ions;
wherein the solution laden with ions is introduced into the solution flow path input, passes through the graphene sheet, thereby resulting in a first ion solution containing the first ions and the second ions on a solution flow path input side of the graphene sheet and a deionized solution on a solution flow path output side of the graphene sheet.

26. The deionizer of claim 25, wherein
the first ions are negatively charged ions;
the second ions are positively charged ions; and
the functionalized plural apertures comprise plural apertures with negatively charged perimeters to repel the negatively charged ions in the solution.

27. The deionizer of claim 25, wherein
the first ions are positively charged ions;
the second ions are negatively charged ions; and
the functionalized plural apertures comprise plural apertures with a positively charged perimeters to repel the positively charged ions in the solution.

28. The deionizer of claim 25, wherein the plural apertures of the graphene sheet are dimensioned to repel the transit of the first ions.

29. The deionizer of claim 25, wherein the graphene sheet is charged with an electrical charge, the electrical charge repelling the first ions.

30. The deionizer of claim 29, wherein the plural apertures of the graphene sheet are dimensioned to repel the transit of the first ions.

31. A solution deionizer, comprising:
a first graphene sheet with first plural apertures functionalized to repel first ions from transiting through the functionalized first plural apertures, the non-transiting first ions influencing second ions in the solution to not transit through the functionalized first plural apertures;
a second graphene sheet with second plural apertures functionalized to repel the second ions in the solution from transiting through the functionalized second plural apertures, the non-transiting second ions influencing the first ions in the solution to not transit through the functionalized second plural apertures;
a solution flow path with an input and an output, wherein the first graphene sheet is downstream from the solution flow path input and the second graphene sheet is between the first graphene sheet and the solution flow path output; and
a source of solution laden with ions;
wherein the solution laden with ions is introduced into the solution flow path input, passes through the first graphene sheet, then passes through the second graphene sheet, thereby resulting in deionized solution at the solution flow path output.

32. The solution deionizer of claim 31, wherein
the first ions are negatively charged ions;
the second ions are positively charged ions;
the functionalized first plural apertures comprises first plural apertures with negatively charged perimeters that repel the negatively charged ions in the solution; and
the functionalized second plural apertures comprises second plural apertures with positively charged perimeters that repel the positively charged ions in the solution.

33. The solution deionizer of claim 31, wherein
the first ions are positively charged ions, and the second ions are negatively charged ions,
wherein the functionalized first plural apertures comprise first plural apertures with positively charged perimeters that repel the positively charged ions in the solution; and
wherein the functionalized second plural apertures comprises second plural apertures with negatively charged perimeters that repel the negatively charged ions in the solution.

34. The solution deionizer of claim 31, wherein the first plural apertures of the first graphene sheet are dimensioned to repel the transit of the first ions and the second plural apertures of the second graphene sheet are dimensioned to repel the transit of the second ions.

35. The solution deionizer of claim 31, wherein the first graphene sheet is charged with a first electrical charge and the second graphene sheet is charged with a second electrical charge, said first electrical charge repelling the first ions and said second electrical charge repelling the second ions.

36. The solution deionizer of claim 35, wherein the first plural apertures of the first graphene sheet are dimensioned to repel the transit of the first ions and the second plural apertures of the second graphene sheet are dimensioned to repel the transit of the second ions.
